(19) United States
(12) Patent Application Publication
(10) Pub. No.: US 2024/0090530 A1
(43) Pub. Date: Mar. 21, 2024

(54) BINDER SYSTEM FOR A PLANT BASED PRODUCT

(71) Applicant: SOCIETE DES PRODUITS NESTLE S.A., Vevey (CH)

(72) Inventors: ISABEL FERNANDEZ FARRES, Barcelona (ES); JONATHAN LOUTAN, Lausanne (CH); ROOSMARIJN ANTOINETTE SCHEERMEIJER, Lausanne (CH)

(21) Appl. No.: 18/254,085

(22) PCT Filed: Nov. 24, 2021
(86) PCT No.: PCT/EP2021/082799

§ 371 Date: May 23, 2023

(30) Foreign Application Priority Data
Nov. 24, 2020 (EP) 20209641.8

(51) Int. Cl. A23J 3/22; A23J 3/16; A23J 3/18; A23L 25/00; A23L 33/21; A23P 30/10

(52) U.S. Cl. CPC A23J 3/227; A23J 3/16; A23J 3/18; A23L 25/30; A23L 33/21; A23P 30/10

(57) ABSTRACT

The present invention relates to a method of making a plant based product, said method comprising a) mixing in water a cold set gelling dietary fibre, preferably psyllium fibre; a heatset gelling plant based ingredient, preferably flour; and op-tonally calcium salt to form a binder aqueous phase; b) adding lipid to the binder aqueous phase and homogenizing to form an emulsion gel binder; and c) mixing plant extract and/or vegetables, cereals and legumes with the emulsion gel binder, and molding and cooking to form a plant based product.

### BACKGROUND

Almost all commercially available vegetarian plant-based products such as vegetable burgers, patties, schnitzels, balls or similar currently use egg white, while vegan options use methylcellulose, gum blends or other additives for achieving optimal binding properties.

Methylcellulose (MC) is the simplest cellulose derivative. Methyl groups (—CH3) replace the naturally occurring hydroxyls at the C-2, C-3 and/or C-6 positions of the cellulose anhydro-D-glucose units. Typically, commercial MC is produced via alkaline treatment (NaOH) for swelling cellulosic fibres to form an alkali-cellulose which would then react with an etherifying agent such as chloromethane, iodomethane or dimethyl sulfate. Acetone, toluene, or isopropanol can also sometimes be added, after the etherifying agent, for tailoring the final degree of methylation. As a result, MC has amphiphilic properties and exhibits the unique thermal behavior of gelling upon heating which is not found in naturally occurring polysaccharide structures.

Gelation is a two-step process in which a first step is mainly driven by hydrophobic interactions between highly methylated residues, and then a second step which is a phase separation occurring at T>60° C. with formation of a turbid strong solid-like material. This gelation behavior upon heating of MC is responsible for the unique performance in cook from raw burgers when shape retention is required upon cooking. It is similar to the performance of an egg white binder.

However, consumers are becoming increasingly concerned about undesirable chemically modified ingredients in their products. Existing solutions for replacing MC involve the use of other additives in combination with other ingredients for achieving desired functionality. Some of those additives also undergo chemical modification during manufacturing to achieve desired functionality.

Carbohydrate based binders can be based on calcium-alginate gels. In order to achieve gelation, a slow acid release (from either glucono-delta-lactone, citric acid, lactic acid) is needed to liberate calcium ions for crosslinking with alginate to form the gel. This process is rather complex to use in application and the functionality is limited to strong, firm gels hence applicable only for specific plant-based products.

The use of starch-based binders has a detrimental effect on texture, leading to products with a pasty, mushy sensory perception which also crumbles when it is cooked. In addition, starches and flours are high glycemic carbohydrates, which might be not desired or recommended for specific consumer populations (for example diabetics or those wishing to limit carbohydrate content).

Almost all plant-based products on the market comprise an additive as part of the binding agent solution.

Due to all those deficiencies, there are nowadays not many vegan plant-based products that are acceptable for consumers in terms of optimal textural attributes and a more label-friendly, natural ingredient list.

There is a clear need for a plant-based, label-friendly, natural binding agent as an analogue to egg white and MC with enhanced functional properties.

### SUMMARY OF INVENTION

The present invention relates to plant-based products having a plant-based, clean label, natural binding agent as a substitute for egg and methylcellulose and its derivatives (for example hydroxypropyl-methylcellulose) in food applications.

The inventors of the present application have surprisingly found a binder which has similar functional properties to methylcellulose. The functional properties refer to binding the plant based product in cold or room temperature conditions (prior to cooking), hence enabling optimal molding and shape retention during storage. Moreover, the binder exhibits a sequential gelling mechanism as function of temperature: a heat-set gelling process occurs on heating to cooking temperature, followed by a cold-set gelling process that takes place on cooling to consumption temperature. This prevents crumbling of the plant based product during cooking while providing a firm bite during consumption.

The texture of the product is improved versus alternative binders such as hydrocolloids (for example alginate, agar, konjac gum) which tend to give gummy mouthfeel.

Moreover, the binder does not exhibit water leakage during storage of the plant based product in the cold when compared to vegetable burgers with binders comprising methylcellulose or other additives.

### Embodiments of the Invention

The present invention relates to the field of plant based products for human consumption.

The present invention relates to a method of making a plant based product, said method comprising mixing a cold set gelling dietary fibre, preferably psyllium fibre.

The present invention further relates to a method of making a plant based product, said method comprising mixing a cold set gelling dietary fibre, preferably psyllium fibre; a heat-set gelling plant based ingredient, preferably flour; optionally calcium salt; lipid; plant extract and/or vegetables, cereals, and legumes; and water.

The invention further relates to a method of making a plant based product, said method comprising
a. Mixing in water a cold set gelling dietary fibre, preferably psyllium fibre; a heat-set gelling plant based ingredient, preferably flour; and optionally calcium salt to form a binder aqueous phase;
b. Adding lipid to the binder aqueous phase and homogenizing to form an emulsion gel binder;
c. Mixing plant extract and/or vegetables, cereals, and legumes with the emulsion gel binder, and
d. Molding and cooking to form a plant based product.

The binder aqueous phase may be formed by mixing at 1000 rpm or greater, preferably about 8000 rpm or greater.

The emulsion gel binder may be formed by homogenizing at 2000 rpm or greater, preferably about 8000 rpm or greater.

Preferably, the plant based product is devoid or substantially devoid of additives.

The plant based product may comprise 20 to 85 wt. %, or 20 to 75 wt. % emulsion gel binder.

The plant extract is preferably a plant protein.

The plant extract may be a textured vegetable protein (TVP) plant extract and/or a high moisture extruded (HME) plant extract. The plant extract can be for example mushrooms, corn, carrots, onions, tomatoes, gluten and/or TVP plant extract or HME plant extract.

The plant extract may be a textured vegetable protein (TVP) plant extract and/or a high moisture extruded (HME) plant extract. Preferably, the plant extract is gluten and/or TVP plant extract or HME plant extract.

Preferably, when the plant extract is a TVP plant extract, the plant based product comprises 55 to 85 wt. %, or 55 to 75 wt. %, or about 65 wt. % emulsion gel binder.

The emulsion gel binder may comprise 0.5 to 20 wt. % cold set gelling dietary fibre, preferably 1 to 10 wt. % cold set gelling dietary fibre, more preferably 1 to 5 wt. % cold set gelling dietary fibre.

Preferably, when the plant extract is a TVP plant extract, the emulsion gel binder comprises about 2.2 wt. % cold set gelling dietary fibre.

The cold set gelling dietary fibre at 6 wt. % in an aqueous solution at 20° C. may exhibit a shear thinning behavior with zero shear rate viscosity above 100 Pa·s.

The cold set gelling dietary fibre at 6 wt. % in an aqueous solution at 7° C. may exhibit a G′ (storage modulus) greater than 40 Pa and G″ (loss modulus) lower than 150 Pa at 1 Hz frequency and a strain of 0.2%.

The cold set gelling dietary fibre at 6 wt. % in an aqueous solution at 60° C. may exhibit a G′ (storage modulus) greater than 4 Pa and G″ (loss modulus) lower than 45 Pa at 1 Hz frequency and a strain of 0.2%.

The cold set gelling dietary fibre at 6 wt. % in an aqueous solution at 20° C. may exhibit a G′ (storage modulus) greater than 30 Pa and G″ (loss modulus) lower than 50 Pa at 1 Hz frequency and a strain of 0.2%.

Preferably, the cold set gelling dietary fibre has a soluble fraction of greater than 50 wt. %, for example between 50 wt. % to 90 wt. %, for example about 70 wt. %.

The cold set gelling dietary fibre may be derived from tubers, for example potato, cassava, yam, or sweet potato, or from vegetables, for example carrot, pumpkin, or squash, or from fruit, for example citrus fruit, or from legumes, for example pulses, or from oilseeds, for example flaxseed, or from psyllium, chia seeds, potato, apple, fenugreek, chickpea, carrot, oat, or citrus fruit.

Preferably, the cold set gelling dietary fibre is derived from psyllium, chia seeds, potato, fenugreek, chickpea, carrot, oat, or citrus fruit. Preferably, the cold set gelling dietary fibre is derived from psyllium, potato, citrus, or fenugreek. The cold set gelling dietary fibre may comprise psyllium fibre in combination with at least one other fibre, for example citrus fibre, wherein the cold set gelling dietary fibre comprises at least 50% psyllium fibre. The citrus fibre may have a soluble fraction greater than 30%, preferably a soluble fraction greater than 40%. Preferably, the cold set gelling dietary fibre is or comprises psyllium fibre.

Preferably, the emulsion gel binder comprises between 1 to 20 wt. % heat-set gelling plant based ingredient or combination of ingredients.

Preferably, when the plant extract is TVP plant extract, the emulsion gel binder comprises about 2.7 wt. % heat-set gelling plant based ingredient.

The heat-set gelling plant based ingredient preferably exhibits a G′ (storage modulus) greater than 130 Pa and G″ (loss modulus) lower than 85 Pa at 1 Hz frequency and a strain of 0.2% at 10 wt. % in an aqueous solution at 60° C., after heating to 90° C.

The heat-set gelling plant based ingredient preferably exhibits a G′ (storage modulus) greater than 130 Pa and G″ (loss modulus) lower than 60 Pa at 1 Hz frequency and a strain of 0.2% at 10 wt. % in an aqueous solution at 60° C., after heating to 90° C.

The heat-set gelling plant based ingredient may be a combination of ingredients, for example a flour and a plant protein isolate or concentrate, or a starch and a plant protein isolate or concentrate.

The heat-set gelling plant based ingredient comprises starch, and/or protein, preferably a combination of starch and protein, for example between 5 to 95 wt. % starch and 5 to 95 wt. % protein.

The heat-set gelling plant based ingredient may comprise between 60 to 80 wt. % starch and 10 to 20 wt. % protein.

For example, the heat-set gelling plant based ingredient may comprise about 70 wt. % starch and about 14 wt. % protein.

The heat-set gelling plant based ingredient may be, for example, quinoa flour, rice flour, buckwheat flour, wheat flour, chickpea flour, pumpkin seed flour, sesame flour, soy flour, lentil flour or combinations of these. Preferably, the heat-set gelling plant based ingredient is quinoa flour or rice flour, most preferably quinoa flour. Preferably, the plant protein isolate or concentrate is, for example, from soy, faba bean, potato, quinoa, pea, canola, rubisco, mung bean, chickpea, hemp, seaweed, lentils, buckwheat. Preferably, the plant protein or concentrate is from soy, faba bean, potato, chia or quinoa.

The heat-set gelling plant based ingredient may be quinoa flour and soy protein isolate, or rice flour and soy protein isolate.

Preferably, the emulsion gel binder comprises (i) heat-set gelling plant based ingredient, and (ii) cold set gelling dietary fibre in a ratio ranging from between 9:1 to 4:6, preferably between 8:2 and 6:4. Preferably, when the plant extract is TVP plant extract, the ratio is about 5:5. Preferably, when the plant extract is HME plant extract, the ratio is about 7:3.

Preferably, the emulsion gel binder exhibits a G′ greater than 20 Pa and a G″ lower than 240 Pa upon heating until 90° C. and a G′ greater than 100 Pa and a G″ lower than 300 Pa upon subsequent cooling until 60° C.

The lipid may be from any plant source. For example, the lipid may be canola oil, sunflower oil, olive oil, or coconut oil. Preferably, the lipid is canola oil and/or coconut oil, or mixtures thereof.

Preferably, the emulsion gel binder comprises calcium salt, for example 0.1 to 10 wt. % calcium salt, more preferably 0.5 to 1.5 wt. % calcium salt.

The emulsion gel binder may further comprise vinegar, preferably between 1 to 10 wt. % vinegar.

The plant based product may comprise 15 to 90 wt. %, plant extract, preferably 20 to 85 wt. % plant extract. Preferably, for a plant based product comprising TVP plant extract, the plant based product comprises 20 to 40 wt. %, or about 32 wt. % TVP plant extract.

The plant extract may be derived from legumes, cereals, fruits, or oilseeds. For example, the plant extract may be derived from soy, pea, wheat, faba bean, chickpea, lentils, citrus fruits, or sunflower.

Preferably, the plant extract is soy protein, pea protein, chickpea protein, faba bean protein, sunflower protein, wheat gluten, and combinations of these.

Preferably, the plant extract is gluten and/or textured vegetable protein, for example textured soy protein, textured pea protein, textured chickpea protein, textured faba bean protein, textured lentil protein, textured sunflower protein, and/or combinations of these. More preferably, the plant extract is textured soy protein and/or textured pea protein.

The plant extract may be made by extrusion to make a textured protein.

The plant based product may comprise 10 wt. % to 95 wt. %, or 20 wt. % to 95 wt. %, or 25 wt. % to 95 wt. %, or 25 wt. % to 85 wt. %, or 25 wt. % to 75 wt. %, or 30 wt. % to 70 wt. %, or 40 wt. % to 70 wt. %, or 50 wt. % to 65 wt. %, 50 wt. % to 60 wt. %, or about 55 wt. % vegetables, legumes and/or cereals are mixed.

The plant based product may be a vegetable burger, vegetable patty, vegetable schnitzels, vegetable ball, or similar. Preferably, the plant based product is a vegetable burger.

Preferably, the plant based product is cooked, for example deep fried, pan fried, microwaved, oven baked, and combinations of these. The plant based product can be stored frozen prior or after cooking.

The plant based product can be packaged, for example in a modified atmosphere.

Preferably, the invention relates to a method of making a vegan plant based product, said method comprising
a. Mixing in water a cold set gelling dietary fibre, preferably psyllium fibre; a heat-set gelling plant based ingredient, preferably flour; and optionally calcium salt to form a binder aqueous phase;
b. Adding lipid to the binder aqueous phase and homogenizing to form an emulsion gel binder;
c. Mixing plant extract and/or vegetables, cereals and legumes with the emulsion gel binder, and
d. Molding and cooking to form a plant based product.

The invention further relates to a plant based product comprising water, plant extract and/or vegetables, cereals, and legumes, lipid, heat-set gelling plant based ingredient, and cold set gelling dietary fibre.

The invention further relates to a plant based product comprising plant extract; and an emulsion gel binder comprising water, lipid, heat-set gelling plant based ingredient, and cold set gelling dietary fibre.

The invention further relates to a plant based product, comprising
a. Plant extract and/or vegetable, cereals, and legumes; and
b. Emulsion gel binder comprising
   i. Cold set gelling dietary fibre, preferably psyllium fibre;
   ii. Heat-set gelling plant based ingredient, preferably flour;
   iii. Lipid;
   iv. Water; and
   v. optional calcium salt.

Preferably, the plant based product is devoid or substantially devoid of additives.

The plant based product may comprise 15 to 85 wt. % emulsion gel binder.

Preferably, the plant based product comprises 20 to 75 wt. % emulsion gel binder, wherein the emulsion gel binder comprises 1.5 to 20 wt. % cold set gelling dietary fibre, and 1.5 to 20 wt. % heat-set gelling plant based ingredient.

Preferably, the plant based product comprises 0.225 to 17 wt. % cold set gelling dietary fibre and 0.225 to 17 wt. % heat-set gelling plant based ingredient.

Preferably, the plant based product comprises 15 to 85 wt. % plant extract and/or vegetables, cereals and legumes; 1 to 5 wt. % cold set gelling dietary fibre; and 1 to 5 wt. % heat-set gelling plant based ingredient.

The plant extract may be a dry form, for example with a moisture content less than 5 wt. %.

The plant extract may be a high moisture extrudate, for example with a moisture content of about 60 wt. %.

The emulsion gel binder may comprise 0.5 to 20 wt. % cold set gelling dietary fibre, preferably 1 to 10 wt. % cold set gelling dietary fibre, more preferably 1 to 5 wt. % cold set gelling dietary fibre.

The cold set gelling dietary fibre at 6 wt. % in an aqueous solution at 20° C. may exhibit a shear thinning behavior with zero shear rate viscosity above 100 Pa·s.

The cold set gelling dietary fibre at 6 wt. % in an aqueous solution at 7° C. may exhibit a G′ (storage modulus) greater than 40 Pa and G″ (loss modulus) lower than 150 Pa at 1 Hz frequency and a strain of 0.2%.

The cold set gelling dietary fibre at 6 wt. % in an aqueous solution at 60° C. may exhibit a G′ (storage modulus) greater than 4 Pa and G″ (loss modulus) lower than 45 Pa at 1 Hz frequency and a strain of 0.2%.

The cold set gelling dietary fibre at 6 wt. % in an aqueous solution at 20° C. may exhibit a G′ (storage modulus) greater than 30 Pa and G″ (loss modulus) lower than 50 Pa at 1 Hz frequency and a strain of 0.2%.

Preferably, the cold set gelling dietary fibre has a soluble fraction of greater than 50%, for example between 50% to 90%, for example about 70%.

The cold set gelling dietary fibre may be derived from tubers, for example potato, cassava, yam, or sweet potato, or from vegetables, for example carrot, pumpkin, or squash, or from fruit, for example citrus fruit, or from legumes, for example pulses, or from oilseeds, for example flaxseed, or from psyllium, chia seeds, potato, apple, fenugreek, chickpea, carrot, oat, or citrus fruit.

Preferably, the cold set gelling dietary fibre is derived from psyllium, chia seeds, potato, fenugreek, chickpea, carrot, oat, or citrus fruit. Preferably, the cold set gelling dietary fibre is derived from psyllium, potato, citrus, or fenugreek. The cold set gelling dietary fibre may comprise psyllium fibre in combination with at least one other fibre, for example citrus fibre, wherein the cold set gelling dietary fibre comprises at least 50% psyllium fibre. The citrus fibre may have a soluble fraction greater than 30%, preferably a soluble fraction greater than 40%. Preferably, the cold set gelling dietary fibre is or comprises psyllium fibre.

Preferably, the emulsion gel binder comprises between 1 to 20 wt. % heat-set gelling plant based ingredient.

The plant based heat-set gelling ingredient preferably exhibits a G′ (storage modulus) greater than 130 Pa and G″ (loss modulus) lower than 60 Pa at 1 Hz frequency and a strain of 0.2% at 10 wt. % in an aqueous solution at 60° C., after heating to 90° C.

The heat-set gelling plant based ingredient comprises starch, and/or protein, preferably a combination of starch and protein, for example between 5 to 95 wt. % starch and 5 to 95 wt. % protein.

The heat-set gelling plant based ingredient may comprise between 60 to 80 wt. % starch and 10 to 20 wt. % protein

For example, the heat-set gelling plant based ingredient may comprise about 70 wt. % starch and about 14 wt. % protein.

The heat-set gelling plant based ingredient may be, for example, quinoa flour, rice flour, buckwheat flour, wheat flour, chickpea flour, pumpkin seed flour, soy flour, chia flour, lentil flour, sesame flour, or combinations of these. Preferably, the heat-set gelling plant based ingredient is quinoa flour or rice flour, most preferably quinoa flour.

Preferably, the emulsion gel binder comprises (i) heat-set gelling plant based ingredient, and (ii) cold set gelling dietary fibre in a ratio ranging from between 9:1 to 4:6, preferably between 8:2 and 6:4. Preferably, when the plant extract is TVP plant extract, the ratio is about 5:5. Preferably, when the plant extract is HME plant extract, the ratio is about 7:3.

Preferably, the emulsion gel binder exhibits a G′ greater than 20 Pa and a G″ lower than 240 Pa upon heating until 90° C. and a G′ greater than 100 Pa and a G″ lower than 300 Pa upon subsequent cooling until 60° C.

The lipid may be from any plant source. For example, the lipid may be canola oil, sunflower oil, olive oil, or coconut oil. Preferably, the lipid is canola oil and/or coconut oil, or mixtures thereof.

Preferably, the emulsion gel binder comprises calcium salt, for example 0.1 to 10 wt. % calcium salt, more preferably 0.5 to 1.5 wt. % calcium salt.

The emulsion gel binder may further comprise vinegar, preferably between 1 to 10 wt. % vinegar.

The plant extract may be derived from legumes, cereals, fruits, or oilseeds. For example, the plant extract may be derived from soy, pea, or wheat.

The plant based product may be a vegetable burger, vegetable patty, vegetable schnitzels, vegetable ball or similar. Preferably, the plant based product is a vegetable burger or vegetable schnitzel.

Preferably, the plant based product is cooked, for example deep fried, pan fried, microwaved, oven baked, and combinations of these. The plant based product can be stored frozen prior or after cooking.

The invention also relates to a plant based product made according to the method as described herein.

The invention further relates to the use of a cold set gelling dietary fibre as a binder for a plant based product.

The invention further relates to the use of a cold set gelling dietary fibre and a heat-set gelling plant based ingredient as a binder for a plant based product.

The invention further relates to the use of a cold set gelling dietary fibre and a heat-set gelling plant based ingredient as an emulsion gel binder for a plant based product.

The invention further relates to the use of water, lipid, heat-set gelling plant based ingredient, cold set gelling dietary fibre, and optionally calcium salt as a binder for a plant based product.

In particular, the invention relates to the use of water, lipid, heat-set gelling plant based ingredient, cold set gelling dietary fibre, and optionally calcium salt as a binder for a plant based product, wherein said water, lipid, heat-set gelling plant based ingredient, cold set gelling dietary fibre, preferably psyllium fibre, and optionally calcium salt are comprised in an emulsion gel binder.

Preferably, the plant based product is devoid or substantially devoid of additives.

The plant based product may comprise 20 to 85 wt. %, or 20 to 75 wt. % emulsion gel binder.

The emulsion gel binder may comprise 0.5 to 20 wt. % cold set gelling dietary fibre, preferably 1 to 10 wt. % cold set gelling dietary fibre, more preferably 1 to 5 wt. % cold set gelling dietary fibre.

The cold set gelling dietary fibre at 6 wt. % in an aqueous solution at 20° C. may exhibit a shear thinning behavior with zero shear rate viscosity above 100 Pa·s.

The cold set gelling dietary fibre at 6 wt. % in an aqueous solution at 7° C. may exhibit a G′ (storage modulus) greater than 40 Pa and G″ (loss modulus) lower than 150 Pa at 1 Hz frequency and a strain of 0.2%.

The cold set gelling dietary fibre at 6 wt. % in an aqueous solution at 60° C. may exhibit a G′ (storage modulus) greater than 4 Pa and G″ (loss modulus) lower than 45 Pa at 1 Hz frequency and a strain of 0.2%.

The cold set gelling dietary fibre at 6 wt. % in an aqueous solution at 20° C. may exhibit a G′ (storage modulus) greater than 30 Pa and G″ (loss modulus) lower than 50 Pa at 1 Hz frequency and a strain of 0.2%.

Preferably, the cold set gelling dietary fibre has a soluble fraction of greater than 50 wt. %, for example between 50 wt. % to 90 wt. %, for example about 70 wt. %.

The cold set gelling dietary fibre may be derived from tubers, for example potato, cassava, yam, or sweet potato, or from vegetables, for example carrot, pumpkin, or squash, or from fruit, for example citrus fruit, or from legumes, for example pulses, or from oilseeds, for example flaxseed, or from psyllium, chia seeds, potato, apple, fenugreek, chickpea, carrot, oat, or citrus fruit.

Preferably, the cold set gelling dietary fibre is derived from psyllium, chia seeds, potato, fenugreek, chickpea, carrot, oat, or citrus fruit. Preferably, the cold set gelling dietary fibre is derived from psyllium, potato, citrus, or fenugreek. The cold set gelling dietary fibre may comprise psyllium fibre in combination with at least one other fibre, for example citrus fibre, wherein the cold set gelling dietary fibre comprises at least 50% psyllium fibre. The citrus fibre may have a soluble fraction greater than 30%, preferably a soluble fraction greater than 40%. Preferably, the cold set gelling dietary fibre is or comprises psyllium fibre.

Preferably, the emulsion gel binder comprises between 1 to 20 wt. % heat-set gelling plant based ingredient.

The plant based heat-set gelling ingredient preferably exhibits a G′ (storage modulus) greater than 130 Pa and G″ (loss modulus) lower than 60 Pa at 1 Hz frequency and a strain of 0.2% at 10 wt. % in an aqueous solution at 60° C., after heating to 90° C.

Preferably, the heat-set gelling plant based ingredient has a starch content between 30 to 90 wt. %, or between 60 to 80 wt. % and a protein content between 5 to 40 wt. %, or between 10 to 20 wt. %.

Preferably, the heat-set gelling plant based ingredient has a starch content between 30 to 80 wt. % and a protein content between 10 to 35 wt. %, preferably 15 to 35 wt. %.

The heat-set gelling plant based ingredient may be, for example, quinoa flour, rice flour, buckwheat flour, wheat flour, chickpea flour, pumpkin seed flour, soy flour, chia flour, sesame flour, or combinations of these. Preferably, the heat-set gelling plant based ingredient is quinoa flour or rice flour, most preferably quinoa flour.

Preferably, the emulsion gel binder comprises (i) heat-set gelling plant based ingredient, and (ii) cold set gelling dietary fibre in a ratio ranging from between 9:1 to 4:6, preferably between 8:2 and 6:4.

Preferably, the emulsion gel binder exhibits a G′ greater than 20 Pa and a G″ lower than 240 Pa upon heating until 90° C. and a G′ greater than 100 Pa and a G″ lower than 300 Pa upon subsequent cooling until 60° C.

The lipid may be from any plant source. For example, the lipid may be canola oil, sunflower oil, olive oil, or coconut oil. Preferably, the lipid is canola oil and/or coconut oil, or mixtures thereof.

Preferably, the emulsion gel binder comprises calcium salt, for example 0.1 to 10 wt. % calcium salt, more preferably 0.5 to 1.5 wt. % calcium salt.

The emulsion gel binder may further comprise vinegar, preferably between 1 to 10 wt. % vinegar.

The plant based product may be a vegetable burger, vegetable patty, vegetable schnitzels, vegetable ball or similar. Preferably, the plant based product is a vegetable burger.

Preferably, the plant based product is cooked, for example deep fried, pan fried, microwaved, oven baked, and combinations of these. The plant based product can be stored frozen prior or after cooking.

### DETAILED DESCRIPTION OF THE INVENTION

Cold Set Gelling Dietary Fibre

Typically, a Newtonian fluid behavior is observed at concentrations below 1 wt. % when the cold set gelling dietary fibre is dispersed in water. Typically, a shear thinning response becomes apparent at concentrations equal or above 1 wt. % when dispersed in water.

A water based solution comprising 6 wt. % of cold set gelling dietary fibre at 7° C. may exhibit the following viscoelastic properties (i) shear thinning behavior with zero shear rate viscosity above 100 Pa·s, (ii) G′ (storage modulus) greater than 40 Pa and G″ (loss modulus) lower than 150 Pa at 1 Hz frequency and a strain of 0.2%. Within the scope of this invention, the shear thinning is defined as a rheological property of any material that exhibits a decrease in viscosity with increasing shear rate or applied stress.

Typically, in a cold set gelling dietary fibre of the invention, modulus G′ is greater than the modulus G″ up to and including at least 100% of applied strain, at concentrations of 6 wt. % when dispersed in water.

Heat-Set Gelling Plant Based Ingredient

Typically, a pre-sheared water based solution comprising 10 wt. % heat-set gelling plant based ingredient at 90° C. exhibits the gel-like properties: i. a G′ (storage modulus) greater than 130 Pa, and ii. G″ (loss modulus) lower than 60 Pa at 1 Hz frequency and a strain 0.2%.

Typically, a pre-sheared water based solution comprising 10 wt. % heat-set gelling plant based ingredient at 60° C. exhibits gel-like properties, for example a minimum of 10 fold increase in G′ upon heating until 90° C. and subsequent decrease to 60° C., or a crossover of G′ and G″ upon heating until 90° C. and subsequent decrease to 60° C. with G′ being higher than G″ at 60° C.

The heat-set gelling plant based ingredient may be a combination of ingredients, for example a flour and a plant protein isolate or concentrate, or a starch and a plant protein isolate or concentrate.

### Definitions

The compositions disclosed herein may lack any element that is not specifically disclosed herein. Thus, a disclosure of an embodiment using the term “comprising” includes a disclosure of embodiments “consisting essentially of” and “consisting of” and “containing” the components identified. Similarly, the methods disclosed herein may lack any step that is not specifically disclosed herein. Thus, a disclosure of an embodiment using the term “comprising” includes a disclosure of embodiments “consisting essentially of” and “consisting of” and “containing” the steps identified. Any embodiment disclosed herein can be combined with any other embodiment disclosed herein unless explicitly and directly stated otherwise.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

The term “wt. %” used in the entire description below refers to weight % of the total composition, for example the total emulsion gel binder composition, or the total plant based product composition.

As used herein, “about,” and “approximately” are understood to refer to numbers in a range of numerals, for example the range of −40% to +40% of the referenced number, more preferably the range of −20% to +20% of the referenced number, more preferably the range of −10% to +10% of the referenced number, more preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

The term “additive” refers to isolated, extracted polysaccharide molecules which typically undergo chemical modification during manufacturing. The term “additive” includes one or more of modified starches, hydrocolloids (for example, carboxymethylcellulose, methylcellulose, hydroxypropylmethylcellulose, konjac gum, carrageenans, xanthan gum, gellan gum, locust bean gum, guar gum, alginates, agar, gum arabic, gelatin, Karaya gum, Cassia gum, microcrystalline cellulose, ethylcellulose); emulsifiers (for example, lecithin, mono and diglycerides, PGPR); whitening agents (for example, titanium dioxide); plasticizers (for example, glycerine); anti-caking agents (for example, silicon-dioxide).

Preferably, the term “additive” includes modified starches, hydrocolloids, and emulsifiers.

Preferably, the term “additive” includes methylcellulose, hydroxypropylmethylcellulose, and konjac gum.

The term ‘emulsion gel’ refers to a semi-solid material comprising a dispersed lipid phase in a continuous water phase. The continuous water phase is structured by soluble, high molecular weight polysaccharides (molecular weight greater than 1 kDa) that can form a cold-set hydrogel via formation of intra-molecular junction zones above a critical concentration, and optionally in the presence of calcium salt. It also refers to biopolymers that can form a hydrogel above a critical concentration via polymer aggregation on heating. The dispersed lipid phase can be liquid oil or crystalized fat.

The term ‘cold-set gelling dietary fibre’ refers to a dietary fibre that can form a gel on cooling via formation of intra-molecular junction zones, for example hydrogen bonds and ionic crosslinks. In one embodiment, the dietary fibre can form a gel by cooling from 90° C. to 60° C.

The cold set gelling dietary fibre may be a fibre with a soluble polysaccharide fraction greater than 50 wt. %. The soluble polysaccharide fraction comprises high molecular weight polysaccharides (molecular weight greater than 1 kDa). In one embodiment, the soluble fraction comprises arabinoxylans polysaccharides. In one embodiment, the source of the dietary fibre is from psyllium.

The term “fibre” or “dietary fibre” relates to a plant-based ingredient that is not completely digestible by enzymes in the human gut system. Dietary fibres are not isolated, extracted polysaccharide molecules. The manufacturing of dietary fibres are limited to physical processes only, for example grinding, and milling. The term may comprise plant based fibre-rich fraction obtained from tubers, for example potato, cassava, yam, or sweet potato, or from vegetables, for example carrot, pumpkin, or squash, or from fruit, for example citrus fruit, or from legumes, for example pulses, or from oilseeds, for example flaxseed, or from potato, apple, psyllium, fenugreek, chickpea, carrot, chia or citrus fruit. The dietary fibre may comprise arabinoxylans, cellulose, hemicellulose, pectin, and/or lignin.

The term “calcium salt” refers to salts of calcium such as calcium chloride, calcium carbonate, calcium citrate, calcium gluconate, calcium lactate, calcium phosphate, calcium glycerophosphate and the like, and mixtures thereof. Preferably, the calcium salt is calcium chloride. All examples shown herein use calcium chloride. The amount of calcium salt typically ranges from 0.5 to 5 wt. %.

The terms “food”, “food product” and “food composition” mean a product or composition that is intended for ingestion by an animal, including a human, and provides at least one nutrient to the animal or human. The present disclosure is not limited to a specific animal.

The term “high shear” as used herein means the use of shear at least 1000 rpm, or at least 2000 rpm.

The term “binder” or “binding system” as used herein relates to a substance for holding together particles and/or fibres in a cohesive mass. It is an edible substance that in the final product is used to trap components of the foodstuff with a matrix for the purpose of forming a cohesive product and/or for thickening the product. Binding systems of the invention may contribute to a smoother product texture, add body to a product, help retain moisture and/or assist in maintaining cohesive product shape; for example, by aiding particles to agglomerate.

The term “substantially devoid” insofar as it relates to an ingredient means that the ingredient is present in an amount of less than less than 0.1 wt. %, or is entirely absent.

The term “textured protein” as used herein refers to plant extract material, preferably derived from legumes, cereals or oilseeds. For example, the legume may be soy or pea, the cereal may be gluten from wheat, the oilseed may be sunflower. In one embodiment, the textured protein is made by extrusion. This can cause a change in the structure of the protein which results in a fibrous, spongy matrix, similar in texture to meat. The textured protein can be dehydrated or non-dehydrated. In its dehydrated form, textured protein can have a shelf life of longer than a year, but will spoil within several days after being hydrated. In its flaked form, it can be used similarly to ground meat.

The term “cereals” includes wheat, rice, maize, barley, sorghum, millet, oats, rye, triticale, fonio and pseudocereals (for example, amaranth, breadnut, buckwheat, chia, cockscomb, pitseed goosefoot, quinoa, and wattleseed).

### BRIEF DESCRIPTION OF FIGURES

FIG. 1: G′, G′ and tan δ as function of frequency for a range of psyllium gels with an increased concentration. The error bars represent the standard deviation of two measurements.

FIG. 2: G′, G″ and tan δ as function of frequency for a range of psyllium gels with an increased concentration. The error bars represent the standard deviation of two measurements.

FIG. 3: G′, G″ and tan δ as function of frequency for a range of psyllium gels with an increased concentration. The error bars represent the standard deviation of two measurements.

FIG. 4: Apparent viscosity values of apple, citrus, potato and psyllium aqueous systems at a shear rate of 0.01 s⁻¹ and temperature of 7° C.

FIG. 5: Frequency dependence of the 6 wt. % psyllium, 6 wt. % potato fibre and 6 wt. % (psyllium+citrus fibre). The error bars represent the standard deviation of two measurements.

FIG. 6: G′, G″ (Pa) and tan δ as function of frequency for psyllium solutions (10 wt. %) measured at constant strain of 0,2%, within the linear viscoelastic region, and temperature and temperature of 60° C. after heating from 7° C. to 90° C. at a heating rate of 5° C./min, and cooling to 60° C. at 5° C./min. The error bars represent the standard deviation of two measurements.

FIG. 7: Tan δ as function of temperature for psyllium solutions (10 wt. %) measured at constant strain of 0,2% and temperature and temperature of 60° C. after heating from 7° C. to 90° C. at a heating rate of 5° C./min, and cooling to 60° C. at 5° C./min. The error bars represent the standard deviation of two measurements.

FIG. 8: tan δ as function of frequency for 25 wt. % pre-sheared quinoa flour aqueous dispersions, measured at constant strain of 0,2% and temperature of 7° C. and at 60° C. after heating from 7° C. to 90° C. at a heating rate of 5° C./min. The error bars represent the standard deviation of two measurements.

FIG. 9: 10 wt. % quinoa solution before (A,C) and after heating until 90° C. and subsequent cooling to 60° C. (B,D) and with (C,D) and without (A,B) treatment using a Silverson L5M-A mixer (2 min at 8000 rpm; 2 mm emulsor screen).

FIG. 10: G′, G″ (Pa) as function of temperature for quinoa flour aqueous dispersions after pre-shearing process in Silverson L5M-A mixer (2 min at 8000 rpm; 2 mm emulsor screen) and High-Pressure homogenizer (two times at 500 Pa). The error bars represent the standard deviation of two measurements.

FIG. 11: G′ (Pa) absolute values of an emulsion gel before heating (7° C.) and temperature of 60° C. after heating from 7° C. to 90° C. at a heating rate of 5° C./min, measured at constant frequency of 1 Hz and strain of 0,2%. (6.4 wt. % quinoa, 1.6 wt. % psyllium, 2.1 wt. % vinegar, 0.4 wt. % calcium chloride, 20 wt. % canola oil). The error bars represent the standard deviation of two measurements.

FIG. 12: G′ (Pa), and G″ (Pa) of the emulsion gel binder (6.4 wt. % quinoa, 1.6 wt. % psyllium, 2.1 wt. % vinegar, 0.4 wt. % calcium chloride, 20 wt. % canola oil) as function of temperature. The error bars represent the standard deviation of two measurements.

FIG. 13: Confocal laser scanning microscopy (CLSM) images of emulsion gels (6.4 wt. % quinoa, 1.6 wt. % psyllium, 20 wt. % canola oil) comprising psyllium and quinoa flour in aqueous phase, and canola oil as dispersed phase.

FIG. 14: Scanning Electron Microscopy (SEM) images of emulsion gel (6.4 wt. % quinoa, 1.6 wt. % psyllium, 20 wt. % canola oil) comprising psyllium and quinoa flour in aqueous phase, and canola oil as dispersed phase. The samples were imaged before heating at 7° C. (image A), and after heating to 90° C. and cooling to 7° C. (image B).

FIG. 15— tan δ as function of frequency for the emulsion gels (2.7 wt. % quinoa, 2.2 wt. % psyllium, 0.8 wt. % calcium chloride, 3.7 wt. % vinegar, 17.8 wt. % canola oil) produced using a Silverson L5M-A mixer and a Ultra-Turrax T25 basic, measured at temperature of 60° C. after cooling from 90° C. at a cooling rate of 5° C./min. The error bars represent the standard deviation of two measurements.

### EXAMPLES

### Example 1

Dietary Fibre Compositions

Table 1 below shows examples of dietary fibres which can be used as single systems or in combination as part of the emulsion gel system. Apple fibre is shown as a negative example. The selection of fibre is based on both composition and rheological properties in aqueous solution.

TABLE 1

| | Psyllium | Potato | Citrus | Apple |
|---|---|---|---|---|
| | fibre | fibre | fibre | fibre |
| Total dietary fibre | 89% | 92% | 74% | 55% |
| Soluble fibre | 70% | 73% | 36% | 10% |
| Insoluble fibre | 17% | 19% | 38% | 45% |
| Starch | 0% | 0% | 0% | 0% |
| Free sugars | 0% | <2% | 8% | N.A. |

Fibres were analyzed according to the official methods of analysis of AOAC International (2005) 18th ed., AOAC International, Gaithersburg, MD, USA, Official Method 991.43. (modified).

### Example 2

Mechanical spectra of psyllium fibre gels at 7° C.

Psyllium solutions were prepared by dispersing the psyllium water in a lab scale mixer for 5 min, and left overnight to ensure complete hydration.

The rheological properties of the fibre suspensions and gels were assessed using a stress-controlled rheometer (Anton Paar MCR 702) equipped with a 50 mm-diameter, serrated plate/plate set-up. To prevent evaporation the sample was covered with a layer of mineral oil and a hood equipped with an evaporation blocker was used.

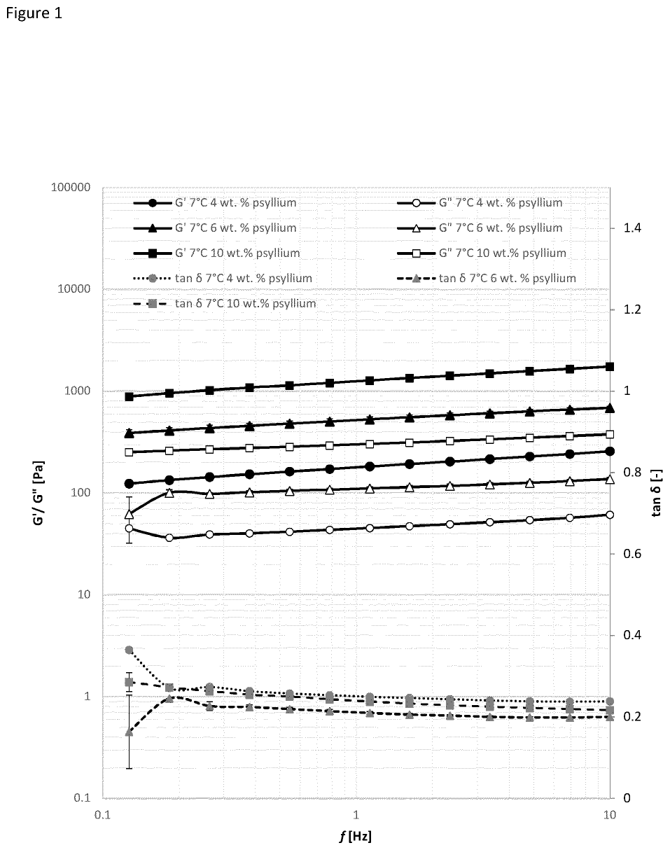

FIG. 1 shows the mechanical spectra (frequency sweeps) of psyllium fibre gels at a range of concentrations in cold conditions. The gel-like response can be seen for all the concentrations where G′ is greater than G″ and nearly independent of frequency, and a tan δ value of 0,2. This rheological fingerprint in cold conditions is required for structuring the water phase of the emulsion gel which will then be used as binder in the plant based product.

The figure shows G′, G′ and tan δ as function of frequency for a range of psyllium gels with an increased concentration. Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz (within the linear viscoelastic region). After this a frequency sweep was applied, during which the frequency was increased from 0.01 to 10 Hz within 4 minutes at a constant strain of 0.2%.

Error bars represent the standard deviation of two measurements.

### Example 3

Mechanical spectra of psyllium fibre gels at 60° C.

Psyllium solutions were prepared by dispersing the psyllium water in a lab scale mixer for 5 minutes and left overnight to ensure complete hydration.

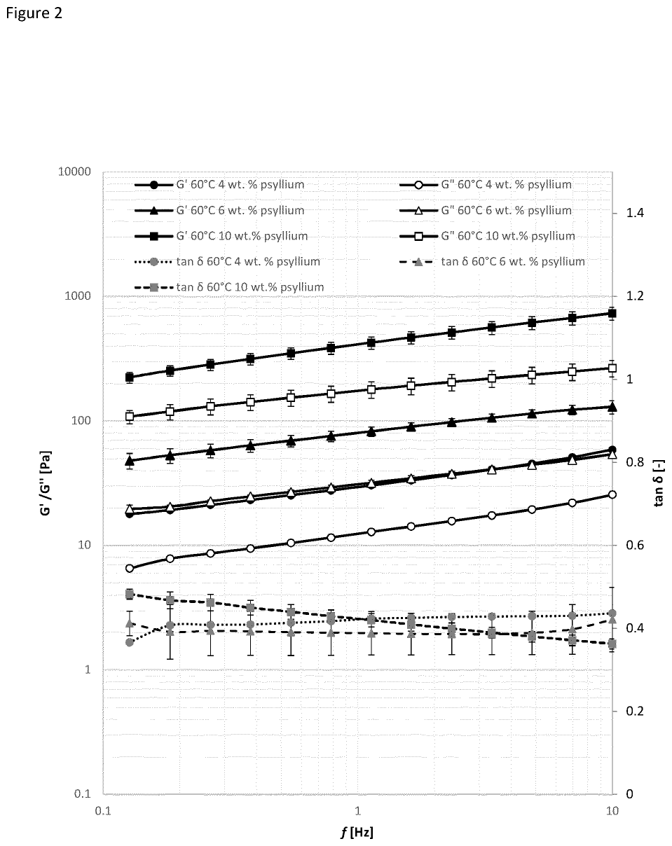

FIG. 2 shows the mechanical spectra (frequency sweeps) of psyllium fibre gels at a range of concentrations in hot conditions.

The figure shows G′, G″ and tan δ as function of frequency for a range of psyllium gels with an increased concentration. Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. After this a frequency sweep was applied, during which the frequency was increased from 0.01 to 10 Hz within 4 minutes at a constant strain of 0.2%. The loss and storage modulus was then measured at a frequency of 1 Hz and a strain of 0.2% while heating from 7° C. to 90° C. at a heating rate of 5° C./min, followed by a 1 minute holding at 90° C. and a subsequent cooling step from 90° C. to 60° C. at 5° C./min. A holding step at 60° C. was then applied for 15 minutes (constant strain of 0,2% and frequency of 1 Hz) followed by frequency and amplitude sweep tests at 60° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

### Example 4

Mechanical spectra of potato fibre gels at 7° C.

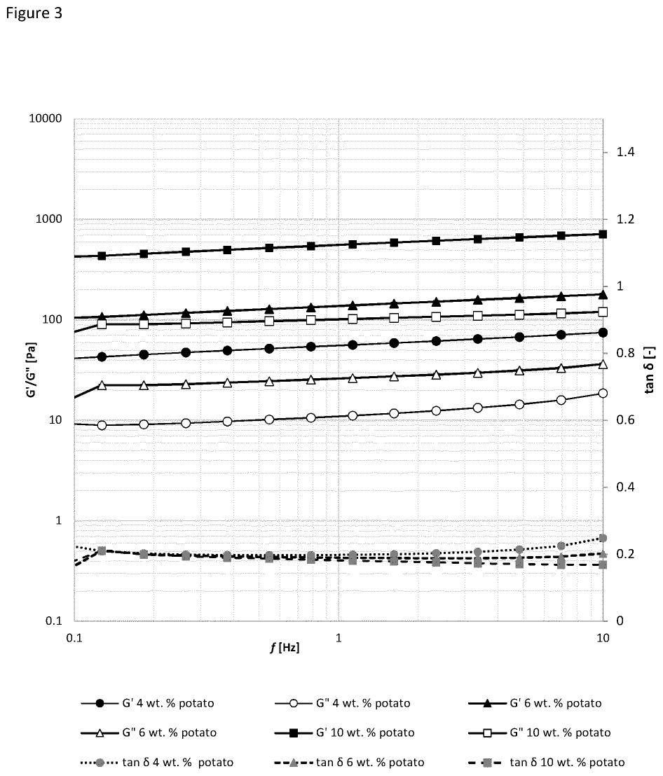

FIG. 3 shows the mechanical spectra (frequency sweeps) of potato fibre gels at a range of concentrations in cold conditions.

The figure shows G′, G″ and tan δ as function of frequency for a range of psyllium gels with an increased concentration. Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. The loss and storage modulus was then measured at a frequency of 1 Hz and a strain of 0.2% while heating from 7° C. to 85° C. at a heating rate of 5° C./min, followed by a 5 minute holding at 85° C. and a subsequent cooling step from 85° C. to 7° C. at 5° C./min. A holding step at 7° C. was then applied for 15 minutes (constant strain of 0,2% and frequency of 1 Hz) followed by frequency and amplitude sweep tests at 7° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

### Example 5

Apparent Viscosity Values of Fibre Dispersions

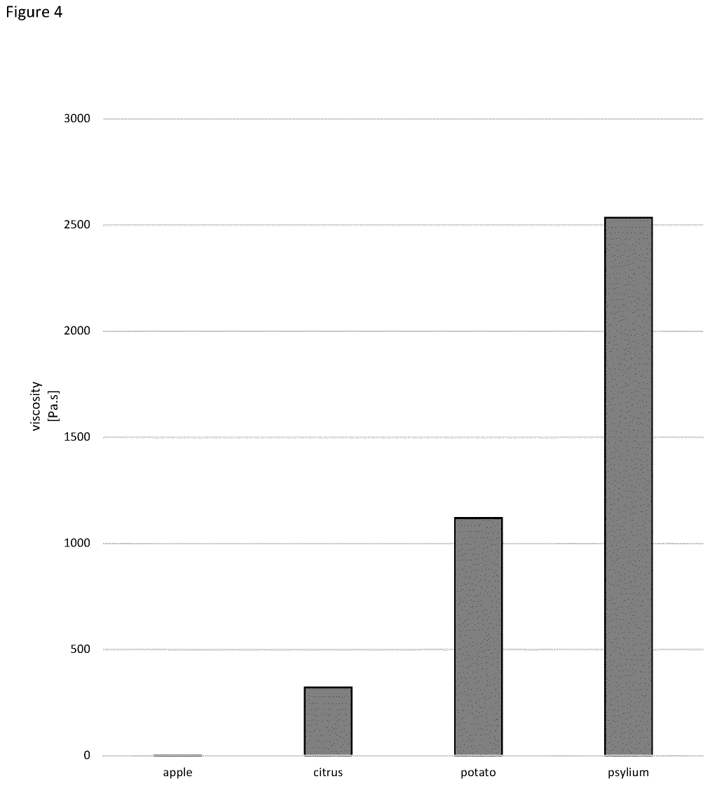

FIG. 4 shows the apparent viscosity values of the psyllium, potato and apple fibres. The low viscosity value of the predominantly insoluble, apple fibre fraction makes it unsuitable to be used to form an emulsion gel and hence an effective binder for plant based product. The apple fibre forms a particulate dispersion where the particles sediment whereas both psyllium and potato fibre have the ability to structure the water phase due to the increased hydrodynamic volume of their soluble, high molecular weight polysaccharides (molecular weight greater than 1 kDa). In cold conditions, intramolecular hydrogen bonding occurs, hence imparting a gel-like behavior (for example, presence of an elastic moduli G′), of those fibre-based dispersions.

The figure shows apparent viscosity values of apple, citrus, potato and psyllium aqueous systems at a shear rate of 0.01 s⁻¹ and temperature of 7° C. A pre-shearing step at 10 s⁻¹/1 min was first applied to the samples at a constant temperature of 7° C., following by a resting step of 10 min at 7° C. Shear rate was then increased from 1*10-5 s⁻¹ to 1000 s⁻¹ in 6 min, then from 1000 s⁻¹ to 1*10-5 s⁻¹ in 6 min.

These fibre-based aqueous dispersions were prepared by dispersing the fibres water in a lab scale mixer for 5 minutes and left overnight to ensure complete hydration.

### Example 6

Apparent Viscosity Values of Fibre Dispersions

Fibre-based aqueous dispersions were prepared by dispersing the fibres in water in a lab scale mixer for 5 minutes and left overnight to ensure complete hydration prior to carrying out the rheological measurements.

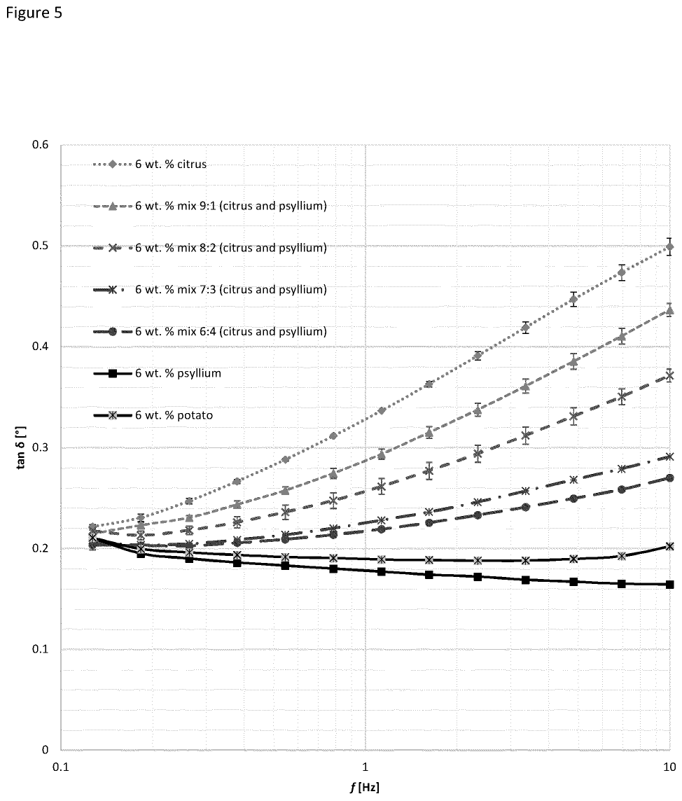

FIG. 5 shows frequency dependence of tans for psyllium fibre gels, potato fibre gels, and psyllium+citrus fibre mixed gels. A low tan δ and independent of frequency indicates a strong, continuous gel-like network. Hence, potato, psyllium and a citrus/psyllium (6:4) mixed fibre system is the preferred choice for creating an emulsion gel to be used as a binder in the plant based product.

In FIG. 5, frequency dependence of the 6 wt. % psyllium, 6 wt. % potato fibre and 6 wt. % (a citrus/psyllium (6:4) mixed fibre system). Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. The loss and storage modulus was then measured at a frequency of 1 Hz and a strain of 0.2% while heating from 7° C. to 85° C. at a heating rate of 5° C./min, followed by a 5 minute holding at 85° C. and a subsequent cooling step from 85° C. to 7° C. at 5° C./min. A holding step at 7° C. was then applied for 15 minutes (constant strain of 0,2% and frequency of 1 Hz) followed by frequency and amplitude sweep tests at 7° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

### Example 7

Effect of Calcium on Psyllium Gel Strength

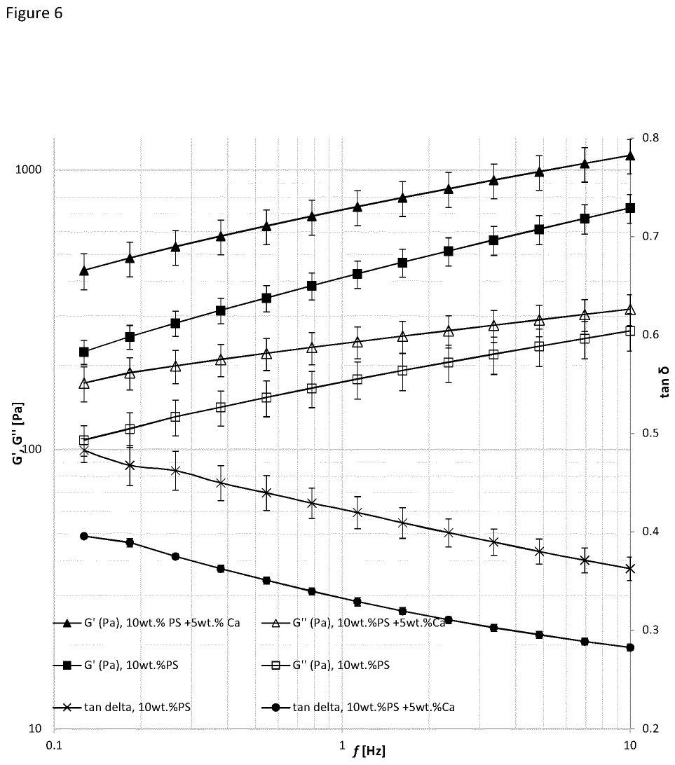

FIG. 6 shows strengthening of the psyllium gel network in the presence of calcium chloride, as the value of G′ is increased and G″ shows a lower frequency dependence compared to the same psyllium gels without added calcium chloride. Increasing the gels also improves binder properties in the burger.

Psyllium solutions were prepared by dispersing the psyllium and calcium chloride in water in a lab scale mixer for 1 min, and left overnight to ensure complete hydration, prior to carrying out the rheological measurements.

Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. After this a frequency sweep was applied, during which the frequency was increased from 0.01 to 10 Hz within 4 minutes at a constant strain of 0.2%. The loss and storage modulus was then measured at a frequency of 1 Hz and a strain of 0.2% while heating from 7° C. to 90° C. at a heating rate of 5° C./min, followed by a 1 minute holding at 90° C. and a subsequent cooling step from 90° C. to 60° C. at 5° C./min. A holding step at 60° C. was then applied for 15 minutes (constant strain of 0,2% and frequency of 1 Hz) followed by frequency and amplitude sweep tests at 60° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

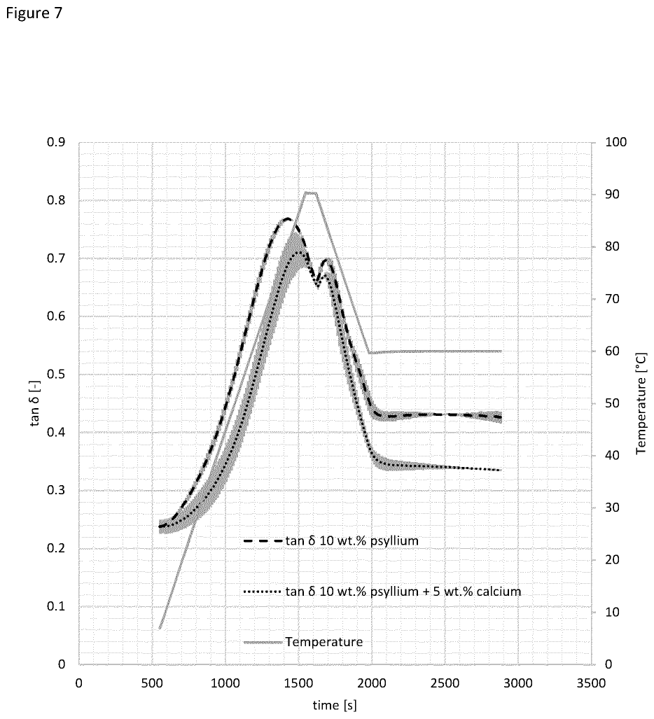

FIG. 7 shows the strengthening of the psyllium gel network in presence of calcium salt upon heating. Upon heating, the maximum tan δ of the psyllium gel without calcium remains higher than the psyllium gel with added psyllium, thus improving the stability upon heating. In a burger, this will result in a better stability upon cooking.

Psyllium solutions were prepared by dispersing the psyllium and calcium salt in water in a lab scale mixer for 1 min, and left overnight to ensure complete hydration, prior to carrying out the rheological measurements.

In FIG. 7, tan δ as function of temperature for psyllium solutions (10 wt. %) measured at constant strain of 0,2% and temperature and temperature of 60° C. after heating from 7° C. to 90° C. at a heating rate of 5° C./min, and cooling to 60° C. at 5° C./min. Psyllium solutions were prepared by dispersing the psyllium powder to water in a lab scale mixer for 1 min and left overnight to ensure complete hydration.

Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. After this a frequency sweep was applied, during which the frequency was increased from 0.01 to 10 Hz within 4 minutes at a constant strain of 0.2%. The loss and storage modulus was then measured at a frequency of 1 Hz and a strain of 0.2% while heating from 7° C. to 90° C. at a heating rate of 5° C./min, followed by a 1 minute holding at 90° C. and a subsequent cooling step from 90° C. to 60° C. at 5° C./min. A holding step at 60° C. was then applied for 15 minutes (constant strain of 0,2% and frequency of 1 Hz) followed by frequency and amplitude sweep tests at 60° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

### Example 8

Heat-Set Gelling Properties of Pre-Sheared Quinoa Flour Water-Dispersions

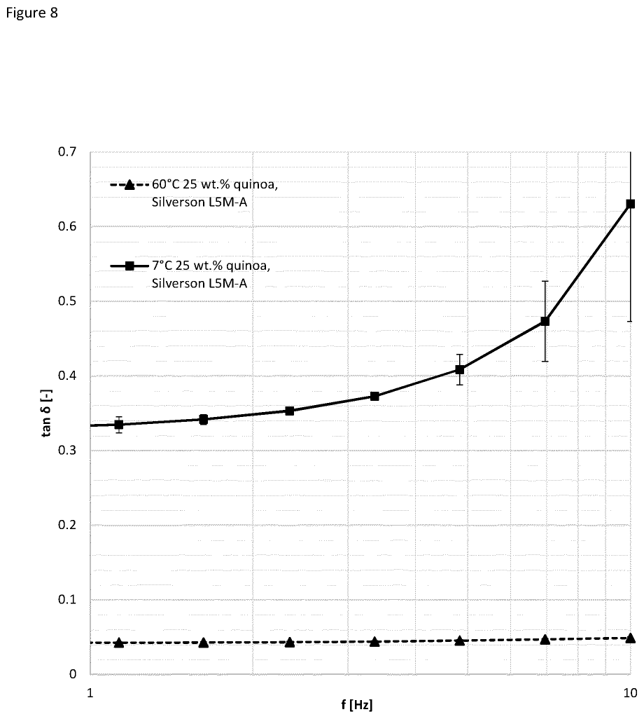

FIG. 8 shows tan δ the change in frequency dependence of quinoa flour dispersions before and after heating until 90° C. and cooling to 60° C. After heating there is a lower frequency dependence, indicating the formation of a gel.

Quinoa flour aqueous dispersions (25 wt. %) were prepared with a lab scale mixer (1 min) and left overnight to ensure full hydration. Afterwards high shear is applied using a Silverson L5M-A mixer (2 min at 8000 rpm; 2 mm emulsor screen).

In FIG. 8, tan δ as function of frequency for 25 wt. % pre-sheared quinoa flour aqueous dispersions, measured at constant strain of 0,2% and temperature of 7° C. and at 60° C. after heating from 7° C. to 90° C. at a heating rate of 5° C./min.

Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. After this a frequency sweep was applied, during which the frequency was increased from 0.01 to 10 Hz within 4 minutes at a constant strain of 0.2%. The loss and storage modulus was then measured at a frequency of 1 Hz and a strain of 0.2% while heating from 7° C. to 90° C. at a heating rate of 5° C./min, followed by a 1 minute holding at 90° C. and a subsequent cooling step from 90° C. to 60° C. at 5° C./min. A holding step at 60° C. was then applied for 15 minutes (constant strain of 0,2% and frequency of 1 Hz) followed by frequency and amplitude sweep tests at 60° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

### Example 9

Heat-Set Gelling Properties of Pre-Sheared and Non Pre-Sheared Quinoa Flour Water-Dispersions

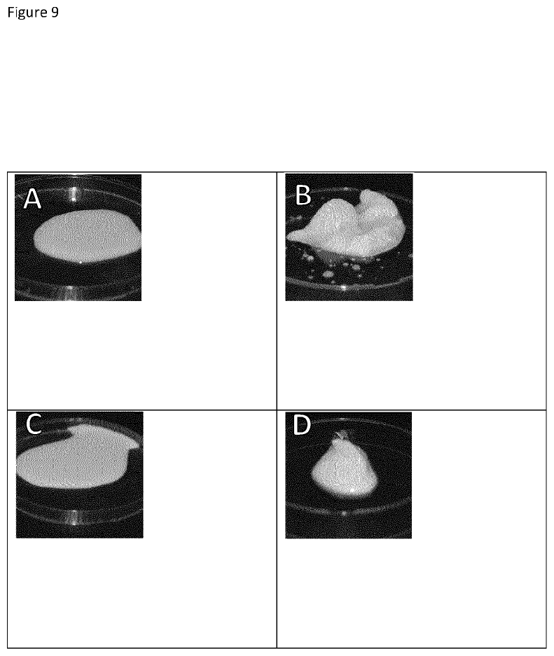

FIG. 9 pictures show that a high shear treatment is needed to form a continuous gel network from quinoa flour after heating.

FIG. 9-B shows a dispersion of quinoa flour particles where water phase ‘leaks out’ of the system, after heating. FIG. 9-D shows a continuous gelled-like material resulting from applying the same heat treatment to pre-sheared quinoa flour water dispersion.

Quinoa flour aqueous dispersions (10 wt. %) were prepared with a lab scale mixer (1 min) and left overnight to ensure full hydration. Afterwards high shear was applied using a Silverson L5M-A mixer (2 min at 8000 rpm; 2 mm emulsor screen) for the samples 9 C-D.

FIG. 9 shows a 10 wt. % quinoa solution before (A,C) and after heating until 90° C. and subsequent cooling to 60° C. (B,D) and with (C,D) and without (A,B) treatment using a Silverson L5M-A mixer (2 min at 8000 rpm; 2 mm emulsor screen).

### Example 10

Effect of Different Pre-Shearing Conditions on Heat-Set Gelling Properties of Quinoa Flour Water-Dispersions

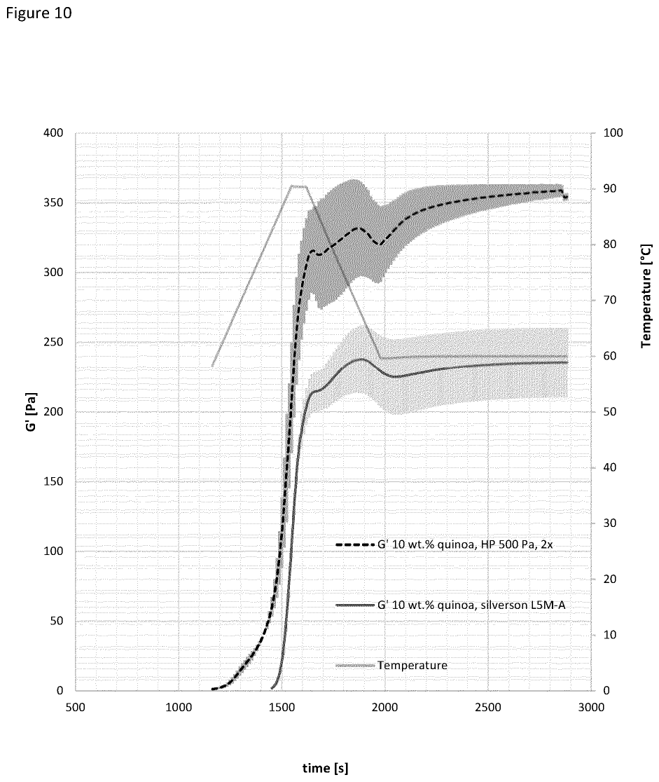

FIG. 10 shows the gelation of quinoa flour upon heating as G′ increases on heating to 90° C. (cooking temperature) and remains with values of similar magnitude (within error bars) when cooling to 60° C. (consumption temperature). High pressure-homogenization has a positive effect on gelling properties as particle size is reduced hence increasing surface area thereby increasing solubilization of the gelling biopolymers present (protein, starch).

35 Quinoa flour aqueous dispersions (10 wt. %) were prepared with a lab scale mixer (1 min) and left overnight to ensure full hydration. In case of the Silverson L5M-A a high shear is applied using a Silverson L5M-A mixer (2 min at 8000 rpm; 2 mm emulsor screen). High pressure homognization was applied with a High-Pressure homogenizer (Niro Soavi Panda) with two runs at 500 Pa.

In FIG. 10, G′, G″ (Pa) as function of temperature for quinoa flour aqueous dispersions after pre-shearing process in Silverson L5M-A mixer (2 min at 8000 rpm; 2 mm emulsor screen) and High-Pressure homogenizer (two times at 500 Pa). Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. After this a frequency sweep was applied, during which the frequency was increased from 0.01 to 10 Hz within 4 minutes at a constant strain of 0.2%. The loss and storage modulus was then measured at a frequency of 1 Hz and a strain of 0.2% while heating from 7° C. to 90° C. at a heating rate of 5° C./min, followed by a 1 minute holding at 90° C. and a subsequent cooling step from 90° C. to 60° C. at 5° C./min. A holding step at 60° C. was then applied for 15 minutes (constant strain of 0,2% and frequency of 1 Hz) followed by frequency and amplitude sweep tests at 60° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

### Example 11

Gel Strength of Emulsion Gel Binder in Cold and in Hot (Eating Temperature)

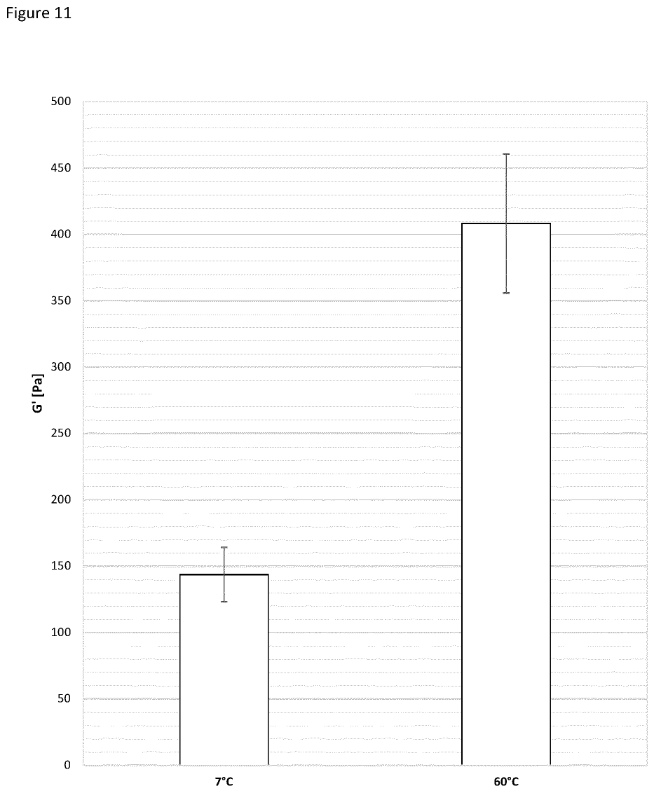

FIG. 11 shows that the gel strength of binder, indicated by the value of G′, increases after heating to 90° C. and subsequent cooling to 60° C.

Samples were prepared by dispersing the quinoa, psyllium, calcium and vinegar in water in a lab scale mixer for 1 minute and left overnight to ensure complete hydration. The next day the oil was added and a high shear was applied using Silverson L5M-A mixer (2 min at 8000 rpm; 2 mm emulsor screen).

FIG. 11 shows G′ (Pa) absolute values of an emulsion gel before heating (7° C.) and temperature of 60° C. after heating from 7° C. to 90° C. at a heating rate of 5° C./min, measured at constant frequency of 1 Hz and strain of 0.2% (6.4 wt. % quinoa, 1.6 wt. % psyllium, 2.1 wt. % vinegar, 0.4 wt. % calcium chloride, 20 wt. % oil).

Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. After this a frequency sweep was applied, during which the frequency was increased from 0.01 to 10 Hz within 4 minutes at a constant strain of 0.2%. The loss and storage modulus was then measured at a frequency of 1 Hz and a strain of 0.2% while heating from 7° C. to 90° C. at a heating rate of 5° C./min, followed by a 1 minute holding at 90° C. and a subsequent cooling step from 90° C. to 60° C. at 5° C./min. A holding step at 60° C. was then applied for 15 minutes (constant strain of 0,2% and frequency of 1 Hz) followed by frequency and amplitude sweep tests at 60° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

### Example 12

Temperature Dependence of Emulsion Gel Binder' G′, Following a Cooking and Eating Temperature Conditions

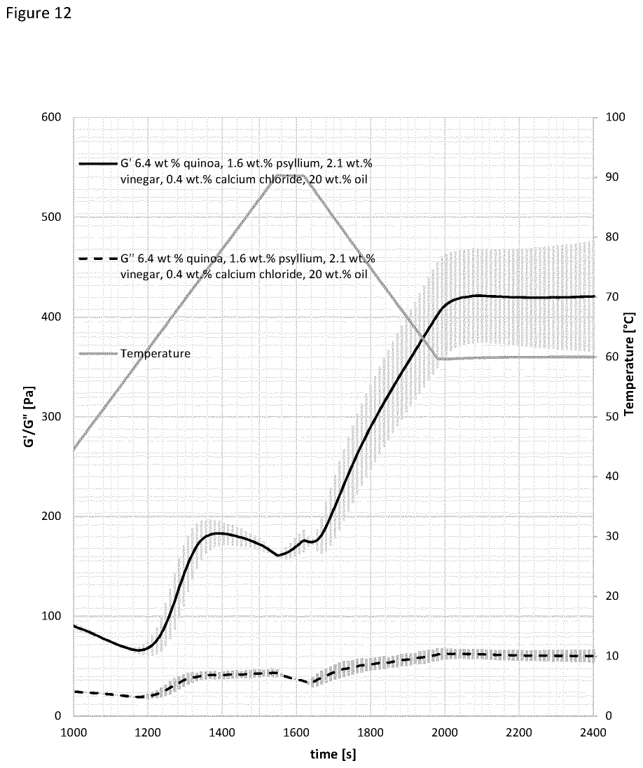

FIG. 12 shows the G′ (Pa), and G″ (Pa) of the emulsion gel binder (6.4 wt. % quinoa, 1.6 wt. % psyllium, 2.1 wt. % vinegar, 0.4 wt. % calcium chloride, 20 wt. % canola oil) as a function of temperature. A sequential two step gelling process is shown: On heating to cooking temperature (90° C.), a concurrent quinoa starch gelatinization followed by quinoa protein gelation takes place, leading to an increase in G′ (elastic moduli) from 143 Pa to 172 Pa. On cooling from 90° C. to consumption temperature (60° C.), psyllium starts to gel hence leading to a further increase in G′ from 172 Pa to 408 Pa. This is the optimal gel-like properties when used as a binder in a plant based product application, allowing the pieces to hold together during cooking as well as imparting a firm bite during consumption.

In FIG. 12, G′ (Pa), and G″ (Pa) of the emulsion gel binder (6.4 wt. % quinoa, 1.6 wt. % psyllium, 2.1 wt. % vinegar, 0.4 wt. % calcium chloride, 20 wt. % canola oil) as function of temperature.

Oscillatory rheological measurements were carried out to monitor the sol-to-gel transition of the different fibers as function of temperature. A resting step of 5 minutes was initially applied to equilibrate the material at 7° C., constant strain of 0.2% and frequency of 1 Hz. After this a frequency sweep was applied, during which the frequency was increased from 0.01 to 10 Hz within 4 minutes at a constant strain of 0.2%. The loss and storage modulus was then measured at a frequency of 1 Hz and a strain of 0.2% while heating from 7° C. to 90° C. at a heating rate of 5° C./min, followed by a 1 minute holding at 90° C. and a subsequent cooling step from 90° C. to 60° C. at 5° C./min. A holding step at 60° C. was then applied for 15 minutes (constant strain of 0,2% and frequency of 1 Hz) followed by frequency and amplitude sweep tests at 60° C. During frequency sweeps, the frequency was increased from 0.01 to 10 Hz within 4 minutes at a constant strain of 0.2%. During strain sweeps, the strain was increased from 0.1 to 100% within 4 minutes at a constant frequency of 1 Hz.

Error bars represent the standard deviation of two measurements.

### Example 13

Change in the Emulsion Gel Microstructure after Heating

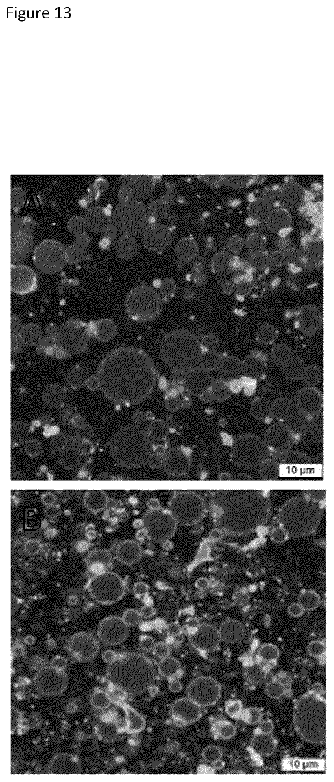

Microscopy pictures indicating a change in the microstructure provided by the protein gelation after heating (FIG. 13). After heating, gelled proteins (in green) appeared at the surface of the oil droplets (in red) as well as the continuous water phase, thus contributing to the gel-like material properties of the emulsion gel binding system. This denser crosslinked gel network of the continuous phase in hot conditions prevents the burger to crumble during cooking and provides a firm bite during consumption.

Emulsion gel samples were prepared by dispersing the quinoa, psyllium and calcium chloride in water using a lab scale mixer for 1 minute and left overnight to ensure complete hydration. The next day the oil was added and a high shear was applied using Silverson L5M-A mixer (2 min at 8000 rpm; 2 mm emulsor screen).

FIG. 13 shows confocal laser scanning microscopy (CLSM) images of emulsion gels (6.4 wt. % quinoa, 1.6 wt. % psyllium, 20 wt. % canola oil) comprising psyllium and quinoa flour in aqueous phase, and canola oil as dispersed phase. The samples were imaged at before heating at 7° C. (image A), and after heating to 90° C. and cooling to 7° C. (image B), using a LSM 710 confocal microscope equipped with an Airyscan detector (Zeiss, Oberkochen, Germany). The samples were loaded inside a 1 mm plastic chamber closed by a glass coverslip to prevent compression and drying artefacts. The image acquisition was performed using an excitation wavelength of 488 and 561 nm, for the Na-Fluorescein and Nile red, respectively.

### Example 14

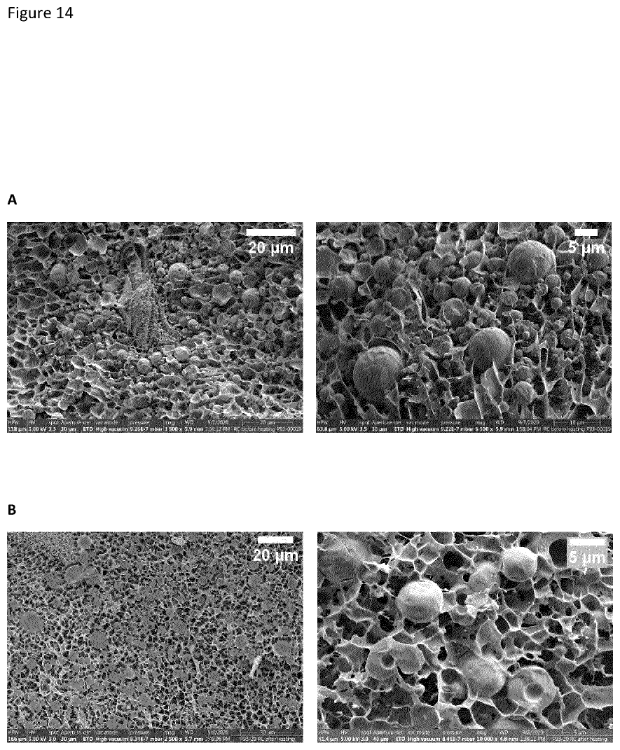

Change in the emulsion gel microstructure after heating Microscopy pictures indicate a change in microstructure after heating (FIG. 14). Before heating there are starch granules present (˜1-3 μm, with flatted sides), which have gelatinized after heating. The crosslinking density of the emulsion gel continuous phase increases after heating.

Emulsion gel samples were prepared by dispersing the quinoa, psyllium and calcium chloride in water using a lab scale mixer for 1 minute and left overnight to ensure complete hydration. The next day the canola oil was added and a high shear was applied using Silverson L5M-A mixer (2 min at 8000 rpm; 2 mm emulsor screen).

FIG. 14 shows scanning Electron Microscopy (SEM) images of emulsion gel (6.4 wt. % quinoa, 1.6 wt. % psyllium, 20 wt. % canola oil) comprising psyllium and quinoa flour in aqueous phase, and canola oil as dispersed phase. The samples were imaged at before heating at 7° C. (image A), and after heating to 90° C. and cooling to 7° C. (image B).

### Example 15

Gel-Like Properties of Emulsion Gel Binders Produced Using Silverson and Ultra-Turrax Equipment

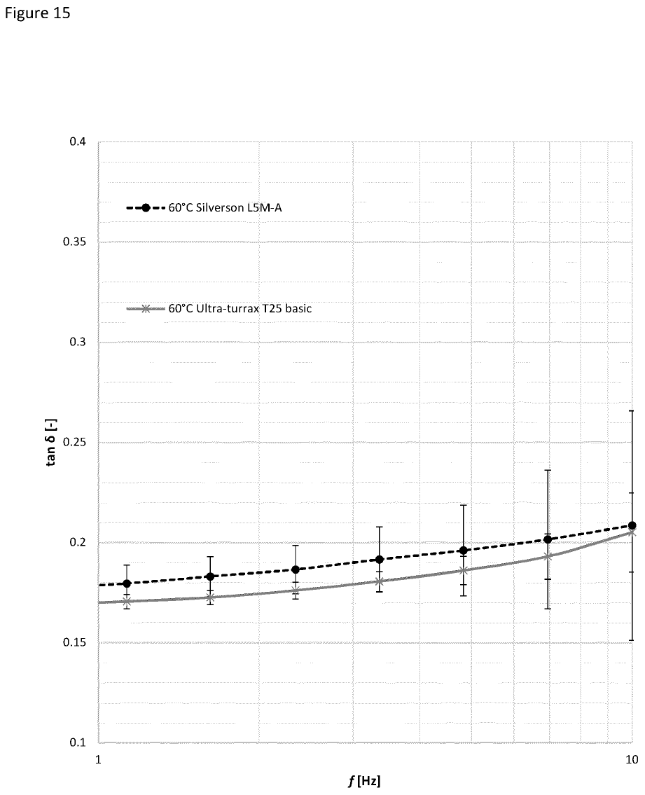

FIG. 15 shows a low frequency dependence of tan δ for the emulsion gels prepared with the Ultra-Turrax and Silverson L5M-A mixer and a tan δ values between 0,15 and 0,2 at temperature of 60° C., indicating that both mixers can be used to prepare an emulsion gel system with the optimal rheological properties to be used at binder in a plant based product.

Silverson L5M-A mixer: Samples were prepared by dispersing the quinoa, psyllium and calcium chloride in water in a lab scale mixer for 1 minute, and left over night for hydration, afterwards the oil was added and a high shear was applied using Silverson L5M-A mixer (2 min at 8000 rpm; 2 mm emulsor screen).

Ultra-Turrax T25 basic mixer: Samples were prepared by dispersing the quinoa, psyllium and calcium chloride in water in a lab scale mixer for 1 minute, and left over night for hydration, afterwards the oil was added and a high shear was applied using an Ultra-Turrax T25 basic (2 min at speed 5).

FIG. 15 shows tan δ as function of frequency for the emulsion gels (2.7 wt. % quinoa, 2.2 wt. % psyllium, 0.8 wt. % calcium chloride, 3.7 wt. % vinegar, 17.8 wt. %) produced using a Silverson L5M-A mixer and a Ultra-Turrax T25 basic, measured at temperature of 60° C. after cooling from 90° C. at a cooling rate of 5° C./min. Error bars represent the standard deviation of two measurements.

### Example 16

Plant Based Recipes

Plant based burger recipes were prepared according to the recipes shown below in Table 2:

TABLE 2

| | Recipe 1 | Recipe 2 | Recipe 3 | Recipe 4 | Recipe 5 | Recipe 6 |
|---|---|---|---|---|---|---|
| soy TVP | 16.00% | 20.00% | 23.00% | 22.00% | 22.00% | 21.50% |
| flavours (incl malt, herbs and spices) | 6.38% | 6.38% | 6.38% | 6.38% | 6.38% | 6.38% |
| Onion Pieces Fried Dried | 1.99% | 1.99% | 1.99% | 1.99% | 1.99% | 1.99% |
| Potato Flakes dried | 1.00% | 1.00% | 1.00% | 1.00% | 1.00% | 1.00% |
| Breader | 5.47% | 5.47% | 5.47% | 5.47% | 5.47% | 5.47% |
| apple puree | 2.99% | 2.99% | 2.99% | 2.99% | 2.99% | |
| gluten | 4.73% | 4.73% | 4.73% | 1.80% | 1.80% | 4.73% |
| ascorbic acid | 0.05% | 0.05% | 0.05% | 0.02% | 0.02% | 0.05% |
| vinergar verdad | 0.45% | 0.45% | 0.45% | 0.17% | 0.17% | 0.45% |
| water for gluten | 7.19% | 7.19% | 7.19% | 2.74% | 2.74% | 7.19% |
| vinegar commercial | 0.18% | 0.18% | 0.18% | 0.07% | 0.07% | 0.18% |
| Quinoa flour | 1.45% | 1.35% | 1.26% | 1.50% | 2.26% | 1.39% |
| Psyllium | 1.20% | 1.11% | 1.04% | 1.24% | 1.86% | 1.14% |
| Calcium chloride | 0.40% | 0.37% | 0.35% | 0.42% | 0.42% | 0.39% |
| Vinegar | 2.49% | 2.48% | 2.47% | 2.49% | 2.49% | 2.55% |
| Water | 38.47% | 35.41% | 33.13% | 39.84% | 38.47% | 36.48% |
| Canola Oil | 9.55% | 8.84% | 8.31% | 9.88% | 9.88% | 9.11% |
| | 100.00% | 100.00% | 100.00% | 100.00% | 100.00% | 100.00% |

A vegetable schnitzel recipe was prepared according to the recipe shown below in Table 3:

TABLE 3

| | Recipe 7 |
|---|---|
| Vegetables | 55.00% |
| Flavoring (salt, pepper, onion powder) | 2.30% |
| Gluten | 4.60% |
| Water, vinegar ascorbic acid solution | 10.30% |
| Quinoa flour | 2.92% |
| Psyllium | 1.90% |
| Calcium chloride | 0.24% |
| Vinegar | 2.29% |
| Water | 15.58% |
| Canola Oil | 4.87% |
| | 100.00% |

Each of the recipes in tables 2 and 3 stayed in the same shape after removal from the mold and did not crumble during cooking process such as flipping in the pan.

For comparison purposes, another recipe was developed in which the psyllium fibre is replaced by apple fibre.

Vegetable balls were prepared according to the recipe shown below in Table 4

TABLE 4

| | |
|---|---|
| Water | 25.5% |
| Oil | 15.3% |
| vegetables/fruits | 41.1% |
| Soy TVP | 8.4% |
| Quinoa | 3.4% |
| psyllium | 1.4% |
| vinegar | 2.4% |
| Starch | 1.3% |
| Salt | 1.0% |
| Pepper | 0.2% |

Vegetable balls stayed in shape during preparation and had a firm texture.

TABLE 5

| | Recipe 9 |
|---|---|
| soy TVP | 16.00% |
| flavours (incl malt, herbs and spices) | 6.38% |
| Onion Pieces Fried Dried | 1.99% |
| Potato Flakes dried | 1.00% |
| Breader | 5.47% |
| apple puree | 2.99% |
| Gluten | 4.73% |
| ascorbic acid | 0.05% |
| vinergar verdad | 0.45% |
| water for gluten | 7.19% |
| vinegar commercial | 0.18% |
| Quinoa flour | 1.45% |
| apple fibre | 1.20% |
| Calcium chloride | 0.40% |
| Vinegar | 2.49% |
| Water | 38.47% |
| Canola oil | 9.55% |
| | 100.00% |

The burger could not be molded and crumbled upon removal from the mold.

1. A method of making a plant based product, said method comprising
a. Mixing in water a cold set gelling dietary fibre; and a heat-set gelling plant based ingredient to form a binder aqueous phase;
b. Adding lipid to the binder aqueous phase and homogenizing to form an emulsion gel binder;
c. Mixing plant extract and/or vegetables, cereals, and legumes with the emulsion gel binder, and
d. Molding and cooking to form a plant based product.

2. The method according to claim 1, wherein the plant based product comprises 20 to 85 wt. % emulsion gel binder.

3. The method according to claim 1, wherein the emulsion gel binder comprises 0.5 to 20 wt. % cold set gelling dietary fibre.

4. The method according to claim 1, wherein the cold set gelling dietary fibre at 6 wt. % in an aqueous solution at 7° C. exhibits a G′ (storage modulus) greater than 40 Pa and G″ (loss modulus) lower than 150 Pa at 1 Hz frequency and a strain of 0.2%.

5. The method according to claim 1, wherein the cold set gelling dietary fibre has a soluble fraction of greater than 50 wt. %.

6. The method according to claim 1, wherein the cold set gelling dietary fibre is or comprises psyllium fibre.

7. The method according to claim 1, wherein the heat-set gelling plant based ingredient exhibits a G′ (storage modulus) greater than 130 Pa and G″ (loss modulus) lower than 60 Pa at 1 Hz frequency and a strain of 0.2% at 10 wt. % in an aqueous solution at 60° C., after heating to 90° C.

8. The method according to claim 1, wherein the heat-set gelling plant based ingredient comprises between 60 to 80 wt. % starch and 10 to 20 wt. % protein.

9. The method according to claim 1, wherein the heat-set gelling plant based ingredient is quinoa flour.

10. The plant based product according to claim 1, wherein the emulsion gel binder exhibits a G′ greater than 20 Pa and a G″ lower than 240 Pa upon heating until 90° C. and a G′ greater than 100 Pa and a G″ lower than 300 Pa upon subsequent cooling until 60° C., at 1 Hz frequency and a strain of 0.2%.

11. The method according to claim 1, wherein the emulsion gel binder comprises 0.1 to 10 wt. % calcium salt.

12. The method according to claim 1, wherein the plant extract is gluten and/or textured vegetable protein, for example textured soy protein, textured pea protein, textured chickpea protein.

13. The method according to claim 1, wherein the plant based product is a vegetable burger.

14. A plant based product comprising
a. Plant extract and/or vegetables, cereals and legumes; and
b. Emulsion gel binder comprising
i. Cold set gelling dietary fibre, preferably psyllium fibre;
ii. Heat-set gelling plant based ingredient, preferably flour;
iii. Lipid; and
iv. Water.

15. (canceled)
